(19) United States
(12) Patent Application Publication
(10) Pub. No.: US 2026/0251115 A1
(43) Pub. Date: Aug. 27, 2026

(54) ENERGY STORAGE SYSTEM

(71) Applicant: John Sale Gilbert, Somers, NY (US)

(72) Inventor: John Sale Gilbert, Somers, NY (US)

(21) Appl. No.: 19/463,504

(22) Filed: Jan. 29, 2026

Related U.S. Application Data
(60) Provisional application No. 63/751,361, filed on Jan. 30, 2025.

(51) Int. Cl. F03B 13/08

(52) U.S. Cl. CPC F03B 13/086

(57) ABSTRACT

An energy storage system including an impoundment pool adjacent to a body of water. An impoundment pool inlet is provided from the body of water into the impoundment pool, in which the impoundment pool inlet is at or below a water level of the body of water. A siphon system is provided from the impoundment pool, and has a siphon inlet within the impoundment pool and a siphon discharge outside of the impoundment pool. The siphon system is configured to maintain a water level within the impoundment pool lower than a water level of the body of water to produce a continuous inflow of water from the body of water into the impoundment pool.

### RELATED APPLICATION(S)

This application claims the benefit of U.S. Provisional Application No. 63/751,361, filed on 30 January 2025, the entire contents of which are incorporated herein by reference.

### TECHNICAL FIELD

This disclosure relates to systems for storing energy and, more particularly, to systems for storing hydroelectric energy.

### BACKGROUND

Pumped Hydro Energy Storage (PHES) is a mature and extensively utilized method for storing and generating electricity. This grid energy storage approach harnesses the gravitational potential energy of water to store and release electricity when needed. The fundamental operation of PHES systems involves two water reservoirs at different elevations, typically an upper and a lower reservoir. During periods of surplus electricity generation, such as off-peak hours or when renewable sources produce excess power, the system uses electricity to pump water from the lower reservoir to the upper reservoir, effectively storing energy as potential energy. When electricity demand spikes, the stored water is released from the upper reservoir, flowing down to the lower reservoir through turbines, which generate electricity during the descent.

Pumped hydro energy storage systems serve a critical role for grid operators as they enable the storage of excess electricity during periods of low demand and its release when demand is high, contributing to grid stability and balancing. This ability to respond swiftly to demand fluctuations makes these systems an essential tool in grid management. They are also known for providing grid stability and serving as emergency backup power sources.

The history of pumped hydro energy storage traces back to the late 19th century, with significant development occurring in the mid-20th century. Iconic facilities, such as the TVA's Raccoon Mountain in the United States, which commenced operations in 1978, exemplify the adoption of this technology. Various countries, including Japan, Germany, and Switzerland, have established their pumped hydro facilities over the years.

These systems offer several advantages: they are highly efficient, with energy conversion efficiencies typically ranging from 70% to 85%, making them a cost-effective and reliable energy storage solution. Their operational lifespan often exceeds 50 years, and they provide a substantial energy storage capacity, rendering them suitable for large-scale grid applications. Moreover, they play a vital role in supporting the integration of renewable energy sources by mitigating their intermittency.

However, the deployment of pumped hydro energy storage does face challenges, primarily related to identifying suitable geographic locations with the necessary topographical and environmental conditions for reservoirs and efficient water cycling. Environmental concerns, including habitat disruption and water usage, must be addressed and regulated.

### SUMMARY OF DISCLOSURE

In one implementation, an energy storage system includes an impoundment pool adjacent to a body of water. An impoundment pool inlet is provided from the body of water into the impoundment pool. The impoundment pool inlet is at or below a water level of the body of water. The energy storage system also includes a siphon system from the impoundment pool. The siphon has a siphon inlet within the impoundment pool and a siphon discharge outside of the impoundment pool, and is configured to maintain a water level within the impoundment pool lower than a water level of the body of water to produce a continuous inflow of water from the body of water into the impoundment pool.

One or more of the following features may be included. The siphon discharge may be lower than the impoundment pool inlet. A turbine generator may be located in an inlet water stream associated with the impoundment pool inlet. The turbine generator may be a bulb turbine generator. An intake conduit may extend between the body of water and the impoundment pool inlet. The inlet water stream associated with the impoundment pool inlet may flow through the intake conduit from the body of water to the impoundment pool inlet. The turbine generator may be at least partially disposed within the intake conduit. The intake conduit may include a venturi system. The venturi system may include an adjustable venturi gate at an entrance of the intake conduit. The venturi system may include a venturi profile within the intake conduit, and the turbine generator may be disposed adjacent to the venturi. The turbine generator may power, at least in part, a pump of a pumped storage energy system.

The energy storage system may include a flow regulator associated with the siphon system. The flow regulator may include one or more electromechanical valves. The flow regulator may include a float valve system. The float valve system may include a float coupled with a valve to open and close the valve based on a water level of the body of water. The valve may include a gate movable relative to a siphon flow path to one or more of at least partially expose the siphon flow path and at least partially block the siphon flow path. The siphon system may include a bundle array of tubes to define a plurality of siphon flow paths between the siphon inlet and the siphon discharge. The impoundment pool may further include an overflow spillway between the impoundment pool and the body of water to allow discharge of overflow water from the impoundment pool.

According to another implementation, an energy storage system includes an impoundment pool adjacent to a body of water. An intake conduit extends between the body of water and an inlet of the impoundment pool. The intake conduit allows a flow of water from the body of water into the impoundment pool. A turbine generator may be at least partially disposed within the intake conduit, wherein the turbine generator may be rotated by the flow of water. A flow concentration system may be included for directing at least a portion of the flow of water one of into the intake conduit and into the turbine generator. The energy storage system further includes a siphon system configured to maintain a water level within the impoundment pool lower than a water level of the body of water. A flow regulator may control a discharge flow rate from the siphon system.

One or more of the following features may be included. The flow regulator may include a gate valve controlled, at least in part, by a float assembly. The gate valve may control the discharge flow rate from the siphon system based upon, at least in part, the water level of the body of water. The siphon system may include a bundle array of a plurality of siphon tubes, each of the plurality of siphon tubes defining a respective siphon flow path. The gate valve may be movably displaceable to expose and block at least a portion of the plurality of siphon tubes to control the discharge flow rate from the siphon system.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an energy storage system configured for left-to-right water flow according to an embodiment of the present disclosure;

FIG. 2 is a diagrammatic view of the energy storage system of FIG. 1 configured for right-to-left water flow according to an embodiment of the present disclosure;

FIG. 3 is a diagrammatic view of an embodiment of an energy storage system utilizing an impoundment pool according to an embodiment of the present disclosure;

FIG. 4 is a cross-sectional diagrammatic view of a portion of an impoundment pool including a siphon system according to an embodiment of the present disclosure; and

FIG. 5 is a cross-sectional diagrammatic view of a flow regulator according to an embodiment of the present disclosure.

Like reference symbols in the various drawings indicate like elements.

### DETAILED DESCRIPTION OF THE PREFERRED EMBODIMENTS

### System Overview

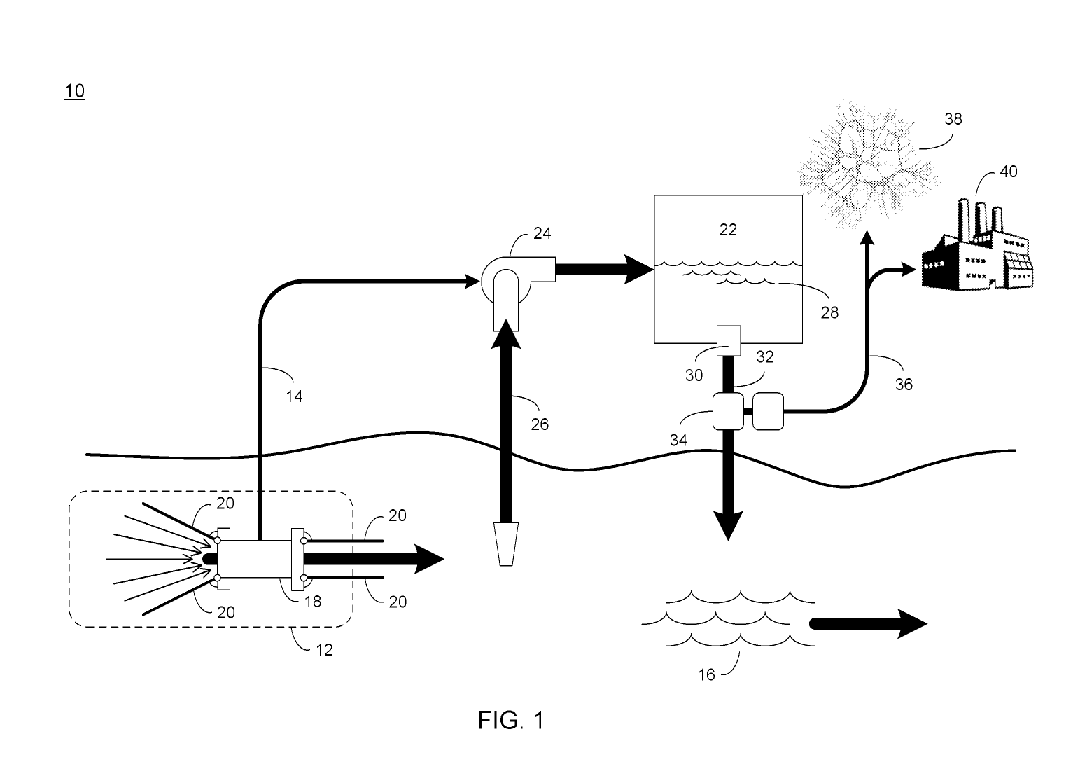

Referring to FIG. 1, there is shown an energy storage system (e.g., energy storage system 10). The energy storage system (e.g., energy storage system 10) may include a current flow energy recovery system (e.g., current flow energy recovery system 12) configured to obtain energy (e.g., obtained energy 14) from a moving water source (e.g., moving water source 16). In this particular figure, the movement (e.g., current) of the water source (e.g., moving water source 16) is from the left to the right.

The current flow energy recovery system (e.g., current flow energy recovery system 12) may be configured to gather energy from bidirectional tidal currents (e.g., moving water source 16). Bidirectional tidal currents, also referred to as reversible tidal currents, are a fundamental characteristic of tidal systems. Tides are the result of gravitational forces from the moon and the sun, causing predictable variations in water levels along coastlines and in estuaries. Bidirectional tidal currents describe the phenomenon where the direction of water flow changes with the rising and falling of the tide.

During the flood tide, water moves landward, toward the shore, as the incoming tide raises the water level. Conversely, during the ebb tide, water flows seaward, away from the shore, as the tide recedes, resulting in a reversal of water flow direction. Tidal slack, a brief period of minimal water movement, marks the transition between the flood and ebb tides when the tidal current velocity briefly comes to a standstill before reversing direction.

These bidirectional tidal currents are a common feature in many coastal regions and estuaries, influencing various marine and environmental processes. Their effects include navigation challenges, impacts on water quality, and implications for marine organisms that rely on tidal patterns for activities such as feeding, spawning, or migration. Moreover, bidirectional tidal currents can be harnessed for renewable energy generation through technologies like tidal stream turbines, which capture the kinetic energy of water movement to produce electricity during both the flood and ebb tides.

The largest tidal currents in the world are found in the Bay of Fundy, located on the eastern coast of North America between the Canadian provinces of New Brunswick and Nova Scotia. The Bay of Fundy is renowned for having the highest tides on the planet, with an average tidal range of about 16 meters (approximately 53 feet). These dramatic tidal fluctuations are a result of the bay's unique geography and the resonance of the tides within the bay.

The tidal currents in the Bay of Fundy are particularly powerful, with peak flow speeds exceeding 20 kilometers per hour (about 12.4 miles per hour) in some areas. The tides in the Bay of Fundy are primarily driven by the gravitational interaction of the Earth, the Moon, and the Sun, and the bay's funnel-like shape amplifies the tidal forces. As a result, the tidal currents in the Bay of Fundy are some of the most impressive and energetic in the world, making it a significant area for tidal energy research and development, as well as a natural wonder that attracts tourists and researchers interested in marine biology and environmental sciences.

Additionally / alternatively, the current flow energy recovery system (e.g., current flow energy recovery system 12) may be configured to gather energy from monodirectional flowing currents (e.g., moving water source 16). Monodirectional flowing currents, as their name implies, are characterized by a continuous and unchanging flow direction. Unlike bidirectional tidal currents that change with the tides, monodirectional currents maintain a constant path. These currents are a common feature in a range of aquatic environments and can be influenced by various factors, including wind, geographical topography, natural ocean currents, and artificial structures. For example, oceanic currents, such as the well-known Gulf Stream, exhibit unidirectional flow patterns as they travel consistently from one location to another. Similarly, river currents flow downstream in a continuous direction, dictated by the landscape's elevation gradient. Man-made canals, like the Panama Canal, are engineered to ensure water moves in one direction to facilitate transportation. Even wind-driven surface currents, influenced by prevailing winds, create monodirectional flows in bodies of water. Understanding monodirectional currents is vital for navigation, environmental management, and infrastructure design, as they have a substantial impact on water movement, aquatic ecosystems, and human activities in aquatic environments.

The current flow energy recovery system (e.g., current flow energy recovery system 12) may include: a turbine generator (e.g., turbine generator 18), such as a water-driven turbine generator, that is rotated by the moving water source (e.g., moving water source 16).

A water-driven turbine generator (e.g., turbine generator 18) is a type of power generation system that harnesses the kinetic energy of flowing water to produce electricity. This technology is commonly used in hydroelectric power plants and is a renewable and environmentally friendly source of energy.

Here's how a water-driven turbine generator (e.g., turbine generator 18) works:

Turbine: The heart of a water-driven turbine generator is the turbine itself. The turbine is a mechanical device with blades or buckets designed to capture the kinetic energy of moving water. The force of the flowing water causes the turbine to rotate.

Generator: Connected to the turbine is an electric generator. As the turbine spins, it turns the generator's rotor. This motion induces the generation of electricity within the generator's stator, where the mechanical energy is converted into electrical energy.

Electricity Production: The electricity produced is typically in the form of alternating current (AC) and is then transmitted to wherever needed. It can be used to power homes, businesses, and industries or stored in batteries for later use.

Water-driven turbine generators (e.g., turbine generator 18) are employed in various settings, including:

Hydroelectric Power Plants: Large-scale hydroelectric power plants use dams and reservoirs to control the flow of water. Water released from the reservoir flows through the turbines to generate electricity. These plants can provide a substantial amount of electrical power to regional grids.

Small Hydropower Installations: Smaller water-driven turbine generators are used in smaller, decentralized hydropower systems. These systems can be found in rural areas, remote communities, and even on individual properties to generate local, sustainable electricity.

Tidal and Wave Energy Systems: In regions with strong tidal or wave activity, water-driven turbines can be used to capture the energy of ocean tides and waves, generating electricity as a result.

Run-of-River Hydropower: Some systems, known as "run-of-river" hydropower, do not require dams or reservoirs. They use the natural flow of rivers or streams to turn turbines and generate electricity, often with less environmental impact compared to large dam projects.

Water-driven turbine generators are highly efficient and produce clean, renewable energy. They contribute to reducing greenhouse gas emissions and dependence on fossil fuels. However, the feasibility and environmental impact of such systems depend on factors like water flow, site location, and regulatory considerations.

An example of the turbine generator (e.g., turbine generator 18) may include but is not limited to: a bulb turbine generator. A bulb turbine generator (e.g., turbine generator 18), often simply called a "bulb turbine," is a type of water turbine and generator used in hydroelectric power plants to convert the kinetic energy of flowing water into electricity. It's a specific design of a water turbine, known for its efficiency and ability to operate at low-head (small height difference between the water source and the generator) hydropower sites. The term "bulb" comes from the bulbous shape of the turbine and generator unit, which is partially submerged in the water.

Here's how a bulb turbine generator (e.g., turbine generator 18) works:

Turbine Blades: The heart of the bulb turbine is the set of turbine blades, which are designed to capture the kinetic energy of water. These blades are mounted on the hub of the turbine.

Bulb Housing: The bulb housing surrounds the turbine and contains the generator. This housing is usually partially submerged in the water, with the generator located in the bulbous section.

Water Flow: Water flows around the bulb housing, causing the turbine to spin as it passes over the blades. The spinning of the turbine is what converts the water's kinetic energy into mechanical energy.

Generator: Inside the bulb housing, the mechanical energy from the rotating turbine is transferred to a generator. The generator contains coils of wire and magnets, and the movement of the turbine rotor induces an electrical current to be generated in the coils.

Electricity Production: The electrical current generated is then transmitted to wherever needed after being conditioned and converted into a more suitable voltage. It can be used to power homes, industries, and various other electrical applications.

Bulb turbines are often used in low-head hydropower installations, such as those in rivers and estuaries where there isn't a significant drop in water level. They are known for their compact design, high efficiency, and minimal environmental impact, making them suitable for a variety of locations. Bulb turbines are particularly well-suited for locations where water flow is constant, as they can efficiently generate electricity under continuous, stable conditions.

The current flow energy recovery system (e.g., current flow energy recovery system 12) may include: a flow concentration system (e.g., flow concentration system 20) for directing at least a portion of the moving water source (e.g., moving water source 16) into the turbine generator (e.g., turbine generator 18). An example of a flow concentration system (e.g., flow concentration system 20) may include a funnel-shaped venturi system for directing at least a portion of the moving water source (e.g., moving water source 16) into the turbine generator (e.g., turbine generator 18).

In this particular example in which moving water source 16 is flowing from left to right, flow concentration system 20 is shown to include four gates, wherein the two left-most gates form a funnel for directing inbound water (shown as five flow arrows) to turbine generator 18. As the velocity of moving water source 16 increases / decreases, the inlet size of the funnel may be adjusted accordingly to maintain proper water flow to turbine generator 18.

A Venturi system (e.g., flow concentration system 20), in the context of fluid dynamics, is a device that employs the Venturi effect to concentrate and accelerate the flow of fluids, typically gases or liquids, through a constricted passage. It's named after its inventor, Giovanni Battista Venturi, an Italian physicist who first described the principle in the 18^{th} century.

The Venturi effect is based on Bernoulli's principle, which states that as the speed of a fluid increases, its pressure decreases. In a Venturi system, fluid flow is concentrated and accelerated as it passes through a narrowing in the pipe or tube.

The key components of a Venturi system (e.g., flow concentration system 20) include:

Inlet: This is where the fluid enters the Venturi system. It usually has a larger cross-sectional area.

Constriction or Throat: In the middle of the Venturi system, the passage narrows, creating a constriction point. This narrowing increases the fluid's velocity and reduces its pressure.

Outlet: After passing through the constriction, the fluid exits the Venturi system. The outlet section typically has a larger cross-sectional area than the throat.

Venturi systems (e.g., flow concentration system 20) are employed in various applications:

Fluid Measurement: Venturi meters are used to measure the flow rate of fluids, such as water or gases. The rate of fluid flow is determined by measuring the pressure difference between the inlet and throat, as this pressure difference is directly related to the flow rate.

Aircraft and Rocket Nozzles: In aerospace engineering, Venturi nozzles are used in aircraft and rocket propulsion systems to accelerate exhaust gases and create thrust. They are a vital component in jet engines and rocket engines.

Fluid Mixing: Venturi systems can be used for mixing two or more fluids. By creating a localized low-pressure region at the constriction point, they encourage thorough mixing of the fluids.

Aeration and Air Injection: Venturi systems can be utilized to introduce air or other gases into liquids for purposes such as water aeration, wastewater treatment, or gas injection in industrial processes.

Fuel Delivery in Internal Combustion Engines: Some carburetors and fuel injection systems in internal combustion engines use Venturi principles to mix fuel and air.

In summary, a Venturi system leverages the Venturi effect to concentrate and accelerate fluid flow through a constricted passage, and it finds application in various fields, including fluid measurement, propulsion, mixing, and aeration. The design of the system optimizes the flow dynamics to achieve desired results in different contexts.

The energy storage system (e.g., energy storage system 10) may include a storage tank (e.g., storage tank 22) configured to store fluid-based potential energy. A fluid storage tank (e.g., storage tank 22) is a container designed to store and hold large quantities of various types of fluids, such as liquids and gases. These tanks come in a wide range of sizes and shapes, depending on their intended use and the properties of the stored fluid. Common examples include water storage tanks, oil storage tanks, chemical storage tanks, and gas storage tanks. Fluid storage tanks serve several crucial purposes, such as providing a reserve of fluids for various applications, including industrial processes, water supply for municipalities, and fuel storage for energy generation. They are constructed from materials like steel, concrete, or plastic, and often feature safety measures to prevent leaks or spills. These tanks play a fundamental role in many industries, from agriculture to manufacturing, by offering a means to store and manage essential fluids efficiently and securely.

As will be discussed below in greater detail, the storage tank (e.g., storage tank 22) may be positioned at least partially above the moving water source (e.g., moving water source 16).

The energy storage system (e.g., energy storage system 10) may include a pumping system (e.g., pumping system 24) configured to utilize the obtained energy (e.g., obtained energy 14) to pump fluid (e.g., fluid 26) from a fluid source into the storage tank (e.g., storage tank 22), thus defining stored fluid (e.g., stored fluid 28). An example of the fluid (e.g., fluid 26) pumped into storage tank 22 may include but is not limited to water from the moving water source (e.g., moving water source 16). Accordingly, the fluid source may be the moving water source (e.g., moving water source 16).

The obtained energy (e.g., obtained energy 14) may be electrical energy and the pumping system (e.g., pumping system 24) may be an electrical pumping system. An electrical pump system (e.g., pumping system 24), often referred to as an electric pump system, is a mechanical system that utilizes an electric motor to generate mechanical work, which, in turn, powers a pump to move or pressurize fluids. These systems are widely used in various industries and applications to transport liquids, gases, or other fluids.

Here's how an electrical pump system (e.g., pumping system 24) typically works:

Electric Motor: At the heart of the system is an electric motor. This motor is powered by electricity, and its primary function is to convert electrical energy into mechanical energy.

Pump: Connected to the electric motor is a pump, which can come in various types, such as centrifugal pumps, diaphragm pumps, or positive displacement pumps. The pump's role is to create a flow of the fluid or gas by applying mechanical force, either by rotating impellers (as in centrifugal pumps) or by reciprocating motion (as in positive displacement pumps).

Fluid Transport: The fluid, whether it's water, oil, chemicals, or any other substance, is drawn into the pump through an inlet. The mechanical action of the pump creates pressure and moves the fluid through the system.

Outlet: The fluid is then discharged through an outlet, where it can be directed to its intended destination, such as supplying water to a household, circulating coolant in an industrial process, or transferring fuel in a storage tank.

Electrical pump systems (e.g., pumping system 24) find extensive use in various sectors, including:

Water Supply and Distribution: Electric pumps are commonly employed in municipal water supply systems, well pumps, and booster pumps to provide a reliable source of water for homes, businesses, and agricultural operations.

Industrial Processes: Many industrial processes, such as chemical manufacturing, food and beverage production, and HVAC systems, rely on electric pump systems to handle the movement and circulation of fluids and coolants.

Wastewater Management: Electric pumps are used in sewage and wastewater treatment facilities to move and treat wastewater and sludge.

Oil and Gas Industry: These systems are used to transport crude oil, refined products, and natural gas through pipelines and in various drilling and extraction processes.

Agriculture: Electric pumps play a critical role in irrigation systems, helping farmers distribute water to crops efficiently.

Environmental Control: Electric pump systems are vital in HVAC (heating, ventilation, and air conditioning) systems, providing temperature control and ventilation in buildings.

The choice of the specific type of pump and its size depends on the application and the characteristics of the fluid being handled. Electric pump systems are highly versatile and are designed to meet the specific needs of various industries, making them essential components in modern infrastructure and manufacturing processes.

Additionally / alternatively, the obtained energy (e.g., obtained energy 14) may be mechanical energy and the pumping system (e.g., pumping system 24) may be a mechanical pumping system. A mechanical pump system (e.g., pumping system 24) is a type of equipment that uses mechanical force to transfer or pressurize fluids, such as liquids or gases. It typically consists of a mechanical pump, which is operated using physical mechanisms, such as a piston or diaphragm, to create a flow or pressure in the fluid. These systems are widely used in various applications to move and manage fluids.

Here's an overview of how a mechanical pump system (e.g., pumping system 24) generally works:

Mechanical Pump: At the core of the system is a mechanical pump, which relies on physical components to create motion. These pumps can take various forms, including diaphragm pumps, piston pumps, gear pumps, or peristaltic pumps, among others.

Input Mechanism: The pump is powered by an input mechanism, which can be manual (like a hand pump), powered by an electric motor, or connected to an internal combustion engine.

Fluid Handling: The fluid to be moved or pressurized is drawn into the pump through an inlet. The mechanical action of the pump creates the necessary force to move or pressurize the fluid.

Outlet: The fluid is then discharged through an outlet and can be directed to the desired destination, whether it's supplying water to a well, distributing chemicals in an industrial process, or circulating coolant in a vehicle's engine.

Mechanical pump systems (e.g., pumping system 24) find widespread use in various industries and applications, including:

Agriculture: Hand or electrically operated mechanical pumps are used for irrigation, allowing farmers to deliver water to their fields.

Automotive: Mechanical pumps are used in vehicles to circulate coolant through the engine and to provide hydraulic power for systems like power steering and brakes.

Industrial Processes: They are commonly found in manufacturing processes, where they move fluids for chemical processing, material handling, and other applications.

Water Wells: Hand pumps are used in remote areas or where access to electricity is limited to draw water from wells.

Oil and Gas Industry: Mechanical pumps play a role in drilling, extraction, and the transportation of oil and natural gas.

Wastewater Management: They are utilized in sewage treatment plants for various fluid handling tasks.

Medical and Laboratory Equipment: Peristaltic pumps, a type of mechanical pump, are used in medical devices and laboratory equipment for precise fluid handling.

The choice of the specific type of mechanical pump and its size depends on the application's requirements and the characteristics of the fluid being handled. These systems are characterized by their mechanical simplicity and are valued for their reliability in many settings.

The energy storage system (e.g., energy storage system 10) may include a drain system (e.g., drain system 30) configured to drain a portion of the stored fluid (e.g., stored fluid 28) within the storage tank (e.g., storage tank 22), thus defining drained fluid (e.g., drained fluid 32). An example of drain system 30 may include but is not limited to an electrically controlled valve assembly. Accordingly, the stored fluid (e.g., stored fluid 28) is potential energy that may be utilized by draining some or all of the stored fluid (e.g., stored fluid 28) from storage tank 22.

The energy storage system (e.g., energy storage system 10) may include an electrical generation system (e.g., electrical generation system 34) configured to receive the drained fluid (e.g., drained fluid 32) and generate electrical energy (e.g., electrical energy 36). An example of the electrical generation system (e.g., electrical generation system 34) may include but is not limited to a turbine generator that is rotated by the drained fluid (e.g., drained fluid 32). Accordingly, the stored fluid (e.g., stored fluid 28) within storage tank 22 may be controllably drained (e.g., via drain system 30) from storage tank 22 to generate electrical energy 36 via electrical generation system 34.

Electrical energy 36 may be e.g., provided to an electrical grid (e.g., electrical grid 38). The electrical grid (e.g., electrical grid 38), commonly known as the power grid or electricity grid, is a complex and interconnected network that facilitates the generation, transmission, and distribution of electricity from power plants to end-users. It serves as the fundamental framework for modern electrical systems, ensuring the reliable supply of electrical energy to meet the diverse needs of consumers. The grid consists of several key components and functions, beginning with power generation at a variety of facilities, including coal, natural gas, nuclear, and renewable energy plants. These power generation sources convert different forms of energy into electrical power.

Following generation, electricity is transmitted over long distances via high-voltage transmission lines and substations to minimize energy loss. Transformers play a crucial role in stepping up and stepping down the voltage for efficient transmission and safe distribution. At the distribution level, electricity is delivered to local communities, businesses, and industries through a network of medium-voltage and low-voltage power lines. Distribution substations further reduce the voltage for safe delivery to end-users' homes and workplaces.

End-users utilize electricity for a wide range of purposes, including lighting, heating, cooling, machinery operation, and the operation of electronic devices. To ensure the grid's stable and reliable operation, grid operators and control centers continuously monitor and manage the flow of electricity in real-time. They make necessary adjustments to balance supply and demand and respond to fluctuations in electricity consumption. Moreover, the grid is designed to accommodate various sources of power generation and adapt to changes in electricity demand. With the integration of advanced technologies, such as smart grids, it aims to enhance efficiency, reliability, and the incorporation of renewable energy sources. The electrical grid is a cornerstone of modern society, powering homes, businesses, industries, and technological advancements, and it plays a pivotal role in economic development and infrastructure.

Additionally / alternatively, electrical energy 36 may be e.g., utilized to power local activities. For example, if the energy storage system (e.g., energy storage system 10) is installed at an industrial complex (e.g., industrial complex 40), electrical energy 36 may be utilized to power local activities at the industrial complex (e.g., industrial complex 40).

As discussed above and with respect to FIG. 1, moving water source 16 is shown to be flowing from left to right, wherein flow concentration system 20 is shown to include four gates. Due to such left to right movement, the two left-most gates form a funnel for directing inbound water (shown as five flow arrows) to turbine generator 18, wherein the inlet size of the funnel may be adjusted to maintain proper water flow to turbine generator 18 if the velocity of moving water source 16 increases / decreases.

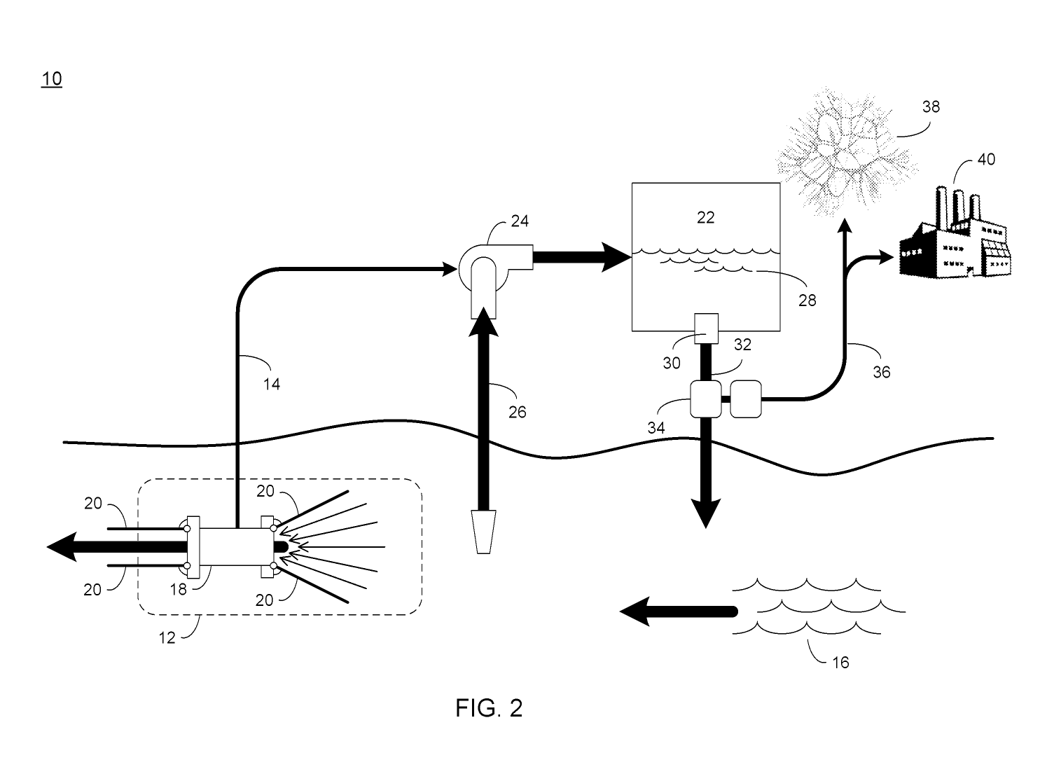

Referring also to FIG. 2, moving water source 16 is shown to be flowing from right to left, wherein flow concentration system 20 is shown to include four gates. Due to such right to left movement, the two right-most gates form a funnel for directing inbound water (shown as five flow arrows) to turbine generator 18, wherein the inlet size of the funnel may be adjusted to maintain proper water flow to turbine generator 18 if the velocity of moving water source 16 increases / decreases.

### Impoundment Pool

Consistent with one aspect of the present disclosure, an impoundment pool may be utilized to provide a constant flow of water from an adjacent body of water. Consistent with such an embodiment, the water level within the impoundment pool may be maintained at a lower level than the water level of the body of water. By maintaining the water level within the impoundment pool lower than the water level of the body of water, water may continuously flow from the body of water into the impoundment pool. According to a particular implementation, flow of water from the body of water into the impoundment pool may be used to spin a generator for generating electricity.

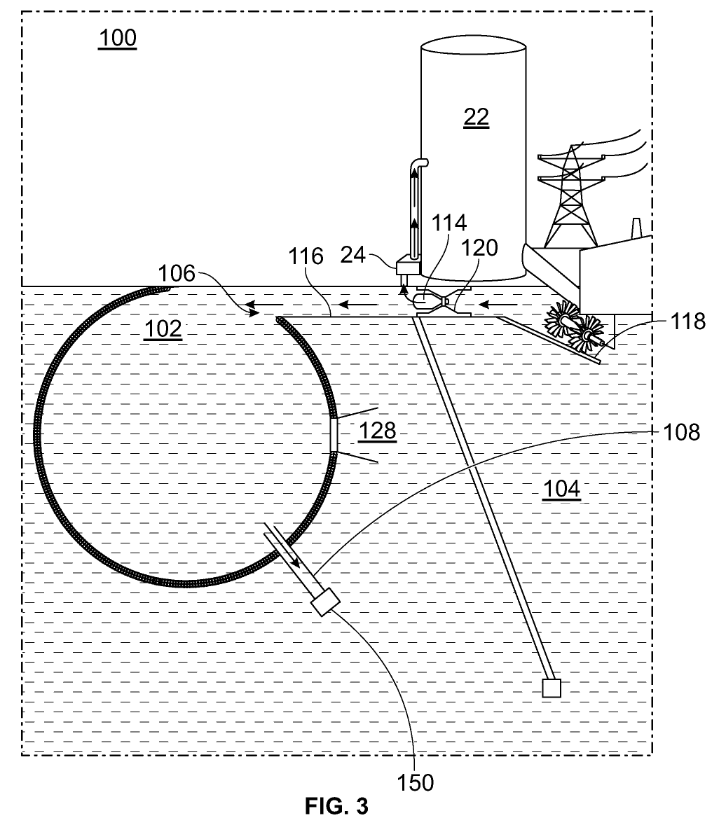

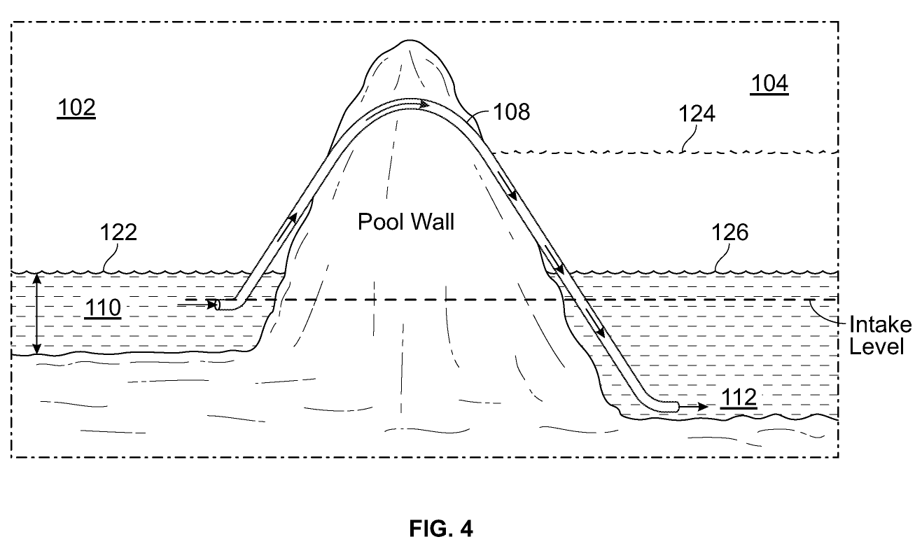

Continuing with the foregoing, and referring also to FIGS. 3 and 4, an illustrative example embodiment of an impoundment pool energy storage system 100 is shown. Generally, the impoundment pool energy storage system 100 may include an impoundment pool 102 adjacent to a body of water 104. An impoundment pool inlet 106, generally, may be provided from the body of water 104 into the impoundment pool 102. Consistent with some embodiments, the impoundment pool inlet may be at or below a water level of the body of water 104. The impoundment pool energy storage system 100 may further include a siphon system 108 from the impoundment pool 102. The siphon system 108 may include a siphon inlet 110 within the impoundment pool 102, and a siphon discharge 112 outside of the impoundment pool 102. The siphon system 108 may be configured to maintain a water level within the impoundment pool 102 lower than a water level of the body of water 104 to provide a continuous inflow of water from the body of water 104 into the impoundment pool 102.

Consistent with the foregoing, the impoundment pool 102 may include any suitable arrangement for containing a volume of water. For example, the impoundment pool may include an upstanding wall for containing a volume of water. The upstanding wall may be formed of any suitable materials, such as, earth, stone, concrete, metal, plastic, or combinations thereof. For example, in one embodiment, the impoundment pool may be defined by an earthen wall, which may be lined, on the inside and/or the outside, with concrete, stone (e.g., masonry, gravel, etc.) plastic (e.g., plastic membrane), or other suitable material to improve the water holding capacity of the impoundment pool (e.g., to prevent and/or reduce the seepage of water through the walls) and/or to prevent and/or reduce erosion of the walls. In other examples, the impoundment pool may include an at least partially enclosed metal, concrete, plastic, etc., structure that may be backed up by soil/earth, which may reduce the structural requirements of the impoundment pool walls and/or bottom. Further, while the illustrated example impoundment pool is shown having a generally circular shape, it will be appreciated that various additional and/or alternative shapes and/or configurations may be equally utilized, including, but not limited to, square, rectangular, polygonal, oval, etc.

The body of water may include any suitable body of water, including, but not limited to, an ocean, sea, lake, reservoir, river, or the like. Consistent with the illustrated example embodiment, the body of water may include an ocean, e.g., which may experience tidal water level fluctuations and/or wave action which may result in cyclical water level variations (e.g., due to changing tides) and/or relatively instantaneous water level variations (e.g., due to wave action, which are not specifically instantaneous, but occur over a relatively short time period). While the body of water in the illustrated example embodiment is an ocean, as noted above, an impoundment pool energy storage system may be used in connection with other bodies of water.

As generally discussed above, the impoundment pool 102 may be adjacent to the body of water 104. In various implementations, the impoundment pool 102 may be at least partially disposed within the body of water 104, as shown in the example embodiment of FIG. 3. That is, for example, the impoundment pool 102 may be a structure formed within and/or located within the body of water 104. Such an arrangement may, in some embodiments, facilitate maintaining the water level within the impoundment pool 102 lower than the water level of the body of water 104. However, in other implementations the impoundment pool may be located next to the body of water (e.g., on or near a shoreline of the body of water). In such an implementation, the impoundment pool may be at least partially sunken or dug into the shore or bank of the body of water to allow the water level within the impoundment pool to be maintained lower than the water level of the body of water. The degree to which the impoundment pool is sunken or dug into the shore or bank of the body of water will depend upon the topography surrounding the body of water. In a further example embodiment, the impoundment pool may not be directly next to the body of water, but may be fluidly coupled with the body of water to allow an inflow of water from the body of water via the impoundment pool inlet 106.

As generally discussed above, the impoundment pool 102 may include an impoundment pool inlet 106 from the body of water 104 into the impoundment pool 102, and the impoundment pool inlet 106 may be at or below a water level of the body of water. Further, as also discussed above, the water level within the impoundment pool 102 may be maintained at a lower level than a water level of the body of water 104. Such an arrangement may produce a continuous flow of water from the body of water 104 into the impoundment pool 102. This may, in effect, create a water current into the impoundment pool. In some implementation, this may be akin to creating a tidal current where none may naturally exist, and or a consistent, unidirectional tidal current, regardless of a prevailing tidal current associated with the body of water.

In some implementations consistent with the present disclosure, the continuous flow of water into the impoundment pool may be utilized for the generation of power. In some implementations, power may be generated in the form of electricity, although it will be appreciated that other forms of power (e.g., mechanical power) may be generated by the continuous flow of water into the impoundment pool. According to one implementation, a turbine generator (e.g., turbine generator 114, shown in FIG. 3) may be located in an inlet water stream associated with the impoundment pool inlet. An example of a turbine generator (e.g., turbine generator 114) may include but is not limited to a bulb turbine generator. As generally discussed above, a bulb turbine generator, which may also generally be referred to simply as a “bulb turbine,” is a type of water turbine and generator used in hydroelectric power plants to convert the kinetic energy of flowing water into electricity. It’s a specific design of a water turbine, known for its efficiency and ability to operate at low-head (small height difference between the water source and the generator) hydropower sites. The term “bulb” comes from the bulbous shape of the turbine and generator unit, which is at least partially submerged in the water.

In general, a bulb turbine generator (e.g., turbine generator 114) may include:

Turbine Blades: The heart of the bulb turbine is the set of turbine blades, which are designed to capture the kinetic energy of water. These blades are mounted on the hub of the turbine.

Bulb Housing: The bulb housing surrounds the turbine and contains the generator. This housing is usually partially submerged in the water, with the generator located in the bulbous section.

Water Flow: Water flows around the bulb housing, causing the turbine to spin as it passes over the blades. The spinning of the turbine is what converts the water's kinetic energy into mechanical energy.

Generator: Inside the bulb housing, the mechanical energy from the rotating turbine is transferred to a generator. The generator contains coils of wire and magnets, and the movement of the turbine rotor induces an electrical current to be generated in the coils.

Electricity Production: The electrical current generated is then transmitted to wherever needed after being conditioned and converted into a more suitable voltage. It can be used to power homes, industries, and various other electrical applications.

Bulb turbines are often used in low-head hydropower installations, such as those in rivers and estuaries where there isn't a significant drop in water level. They are known for their compact design, high efficiency, and minimal environmental impact, making them suitable for a variety of locations. Bulb turbines are particularly well-suited for locations where water flow is constant, as they can efficiently generate electricity under continuous, stable conditions.

Consistent with some implementation of the present disclosure, an intake conduit (e.g., intake conduit 116) may extend between the body of water 104 and the impoundment pool inlet 106. The inlet water stream associated with the impoundment pool inlet 106 may flow through the intake conduit 116 from the body of water 104 to the impoundment pool inlet 106. As shown in the example embodiment of FIG. 3, in some implementations the turbine generator (e.g., turbine generator 114) may be at least partially disposed within the intake conduit 116.

The energy storage system (e.g., energy storage system 100) may include a flow concentration system for directing at least a portion of inflow of water into the impoundment pool (e.g., generally indicated by the right-to-left arrows within the intake conduit 116 in the example embodiment of FIG. 3) into the turbine generator (e.g., turbine generator 114). An example of a flow concentration system may include a funnel-shaped venturi system for directing at least a portion of the inflow of water into the turbine generator (e.g., turbine generator 114).

Consistent with the particular illustrated example embodiment in which the inflow of water is flowing from right to left, the flow concentration system (e.g., which may include a venturi associated with the intake conduit 116) is shown to include at least one adjustable gate (e.g., adjustable gate 118). The adjustable gate may allow an angle of the gate to be varied for directing the inflow of water to the turbine generator 114. In other implementations, the venturi may include a fixed gate or wall for directing the flow of water into the intake conduit 116 and/or the turbine generator 114. As the velocity of inflow of water increases / decreases, the inlet size of the funnel may be adjusted accordingly to maintain proper water flow to the turbine generator 114.

A venturi system (e.g., the venturi system provided at least in part by adjustable gate 118), in the context of fluid dynamics, is a device that employs the Venturi effect to concentrate and accelerate the flow of fluids, typically gases or liquids, through a constricted passage. It's named after its inventor, Giovanni Battista Venturi, an Italian physicist who first described the principle in the 18^{th} century.

The Venturi effect is based on Bernoulli's principle, which states that as the speed of a fluid increases, its pressure decreases. In a venturi system, fluid flow is concentrated and accelerated as it passes through a narrowing in the pipe or tube.

The key components of a venturi system (e.g., such as provided by adjustable gate 118) include:

Inlet: This is where the fluid enters the Venturi system. It usually has a larger cross-sectional area.

Constriction or Throat: In the middle of the Venturi system, the passage narrows, creating a constriction point. This narrowing increases the fluid's velocity and reduces its pressure.

Outlet: After passing through the constriction, the fluid exits the Venturi system. The outlet section typically has a larger cross-sectional area than the throat.

Venturi systems (e.g., such as that provided, at least in part, by adjustable gate 118) are employed in various applications:

Fluid Measurement: Venturi meters are used to measure the flow rate of fluids, such as water or gases. The rate of fluid flow is determined by measuring the pressure difference between the inlet and throat, as this pressure difference is directly related to the flow rate.

Aircraft and Rocket Nozzles: In aerospace engineering, Venturi nozzles are used in aircraft and rocket propulsion systems to accelerate exhaust gases and create thrust. They are a vital component in jet engines and rocket engines.

Fluid Mixing: Venturi systems can be used for mixing two or more fluids. By creating a localized low-pressure region at the constriction point, they encourage thorough mixing of the fluids.

Aeration and Air Injection: Venturi systems can be utilized to introduce air or other gases into liquids for purposes such as water aeration, wastewater treatment, or gas injection in industrial processes.

Fuel Delivery in Internal Combustion Engines: Some carburetors and fuel injection systems in internal combustion engines use Venturi principles to mix fuel and air.

In summary, a Venturi system leverages the Venturi effect to concentrate and accelerate fluid flow through a constricted passage, and it finds application in various fields, including fluid measurement, propulsion, mixing, and aeration. The design of the system optimizes the flow dynamics to achieve desired results in different contexts.

According to some implementations the venturi system may additionally and/or alternatively include a venturi profile within the intake conduit (e.g., venturi profile 120), and the turbine generator 114 may be disposed adjacent to the venturi. In a similar manner as generally discussed above, the venturi profile 120 may concentrate the fluid flow (e.g., water inflow) an accelerate the flow as it passes through a narrowing in the pipe or tube. This may increase the velocity of the inflow of water passing through/by the turbine generator 114.

The electricity generated by the turbine generator (e.g., turbine generator 114) may be utilized for any desired purposes. According to one example embodiment, the turbine generator may power, at least in part, a pump of a pumped energy storage system. For example, as generally described above, one implementation of an energy storage system may generally include a storage tank, (e.g., storage tank 22) configured to store fluid-based potential energy. A pumping system (e.g., pumping system 24) may be configured to pump a fluid from a fluid source (e.g., the body of water 104), into the storage tank (e.g., storage tank 22). The fluid within the storage tank (e.g., storage tank 22) may be released though a drain, and the energy of the released fluid may be captured to, e.g., generate electrical and/or mechanical energy. Consistent with some such implementations, electricity generated by the turbine generator 114 may at least partially power pumping system 24 for pumping fluid (e.g., water from the body of water 104) into the storage tank 22 store fluid-based potential energy. In some implementations, the electricity generated by turbine generator 114 may be the sole power source for the pumping system and/or may be utilized in conjunction with other power sources (such as those generally discussed above).

Continuing with the foregoing description, the energy storage system may include a siphon system (e.g., siphon system 108) from the impoundment pool. The siphon system 108 may include a siphon inlet 110 within the impoundment pool 102 and a siphon discharge 112 outside of the impoundment pool 102. Further, the siphon system may be configured to maintain a water level within the impoundment pool lower than a water level of the body of water to produce a continuous inflow of water from the body of water into the impoundment pool. For example, as generally discussed above, the siphon system 108 may provide an outflow of water from the impoundment pool 102. This outflow of water from the impoundment pool 102 may be configured to maintain a water level within the impoundment pool (e.g., impoundment pool water level 122) that has a relatively constant height. Additionally, the impoundment pool water level 122 may be maintained at a height that is below the water level of the body of water 104, thereby providing for a continuous inflow of water from the body of water 104 into the impoundment pool.

Consistent with some embodiments, as generally discussed above, the body of water may include an ocean, or another body of water that may have a variable water level (e.g., due to tidal fluctuations or the like). For example, in an embodiment in which the body of water may include an ocean the water level of the ocean may fluctuate between a high tide water level (e.g., high tide water level 124) and a low tide water level (e.g., low tide water level 126). In such an embodiment, siphon system 108 may maintain an impoundment pool water level 122 the is lower than (i.e., below) both of the high tide water level 124 and the low tide water level 126. Further, in some example embodiments, the siphon system may be controlled to provide an impoundment pool water level 122 that is lower than a current water level of the body of water. For example, the siphon system 108 may control the impoundment pool water level 122 to be lower than the high tide water level 124 when the body of water 104 is in a high tide state. Further, the siphon system 108 may control an impoundment pool water level 122 to be lower than the low tide water level when the body of water 104 is in a low tide state. Similarly, the siphon system 108 may control an impoundment pool water level 122 to be below a current water level of the body of water 104 when the water level of the body of water is between the high tide water level 124 and the low tide water level 126.

Consistent with such an arrangement in which the impoundment pool water level 122 is maintained below the water level of the body of water, a continuous flow of water may be provided from the body of water into the impoundment pool 102. The outflow of water from the impoundment pool 102 via the siphon system 108 may offset the inflow of water from the body of water 104 via the impoundment pool inlet 106. According to an example embodiment, the siphon discharge 112 may be lower than the impoundment pool inlet 110. As such, water may be discharged from the impoundment pool at any impoundment pool water level 122 that is above the siphon system impoundment pool inlet.

As generally discussed above, by maintaining the impoundment pool water level at a height below the water level of the body of water, water may continuously flow from the body of water into the impoundment pool. In order to maintain the desired height of the impoundment pool water level, the amount of water discharged from the impoundment pool via the siphon system may depend on the inflow rate of water into the impoundment pool from the body of water. In some embodiments, the inflow rate of water into the impoundment pool from the body of water may depend, at least in part, on a height of the water level of the body of water. As discussed above, in some implementations (such as when the body of water is an ocean), the height of the water level of the body of water may vary. Accordingly, consistent with some implementations, the energy storage system may include a flow regulator associated with the siphon system. In general, the flow regulator may control, at least in part, a discharge rate of water through the siphon system. Accordingly, the outflow of water from the impoundment pool via the siphon system may be varied to maintain a desired impoundment pool water level, including in situations in which the inflow of water into the impoundment pool from the body of water may vary. The flow regulator of the siphon system may be located at any desired location in the siphon system, including, but not limited to, a siphon system impoundment pool inlet 110, a siphon system discharge 112, and/or some location between the inlet 110 and the discharge 112.

Consistent with various embodiments, the flow regulator may be implemented in a variety of ways. For example, the flow regulator may include one or more electromechanical valves that may be actuated to open an close the water flow path through the siphon system to varying degrees. According to various implementations, the electromechanical valves may include, but are not limited to, gate valves, butterfly valve, ball valves, pinch valve, etc., In any such arrangement the valve mechanism may be operated by an electronic control system and/or actuator that may one or more of, control a degree of opening and/or closing of the valve (which may vary over time, e.g., based on a water level of the body of water and a water level of the impoundment pool), and may actuate the valve to a desired open/closed state (e.g., via an electric motor, a solenoid actuator, or other suitable arrangement). When the flow regulator includes an electromechanical actuator, the flow regulator may be powered by a battery, the turbine generator, or another suitable power source.

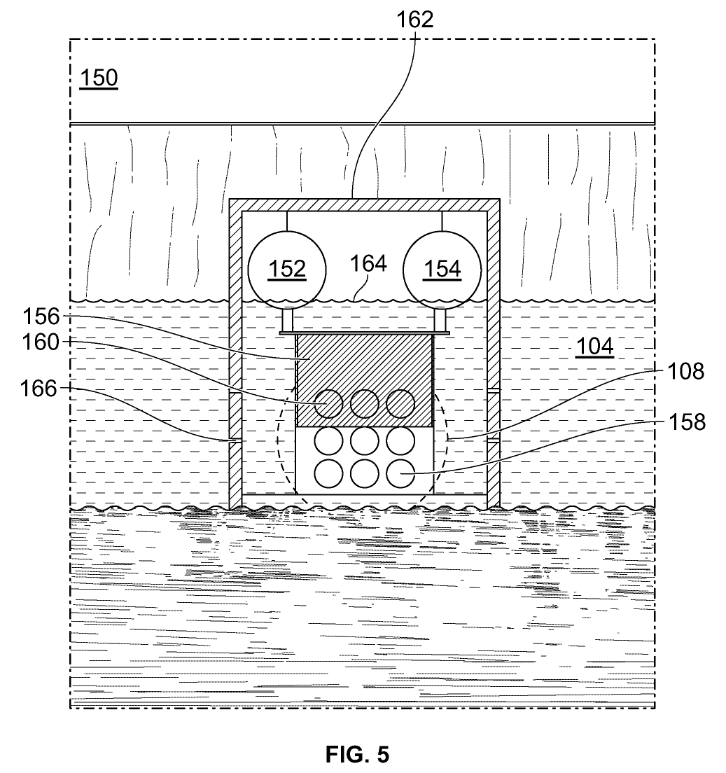

Consistent with one example embodiment, the flow regulator may include a float valve system. For example, and with reference also to FIG. 5, an illustrative example embodiment of a float valve system 150 is generally depicted from an ocean-facing side. In general, the float valve may include one or more floats (e.g., floats 152, 154) coupled with (either directly and/or indirectly via one or more additional mechanisms) a valve to open and close the valve based on a water level of the body of water 104. Consistent with an example embodiment, the valve may include a gate (e.g., gate 156) movable relative to a siphon flow path to one or more of at least partially expose the siphon flow path and at least partially block the siphon flow path. As such, the movable gate 156 may allow a greater or lesser amount of discharge (or discharge rate) from the siphon. In the illustrated example embodiment of FIG. 5, the gate 156 is shown as a vertically movable gate, however, in other embodiments the gate may move horizontally and/or rotationally to at least partially expose or block the siphon flow path. In such configurations, the floats may be coupled with the gate via one or more suitable linkages or mechanical arrangements.

In some example embodiments, the siphon system may include a bundle array of tubes to define a plurality of siphon flow paths between the siphon inlet and the siphon discharge. For example, as shown siphon system 108 may include nine individual tubes that may be generally aligned and/or bundled together to provide the siphon flow path, with each of the individual tubes providing a discrete flow path. As such, rather than one single tube capable of accommodating a desired flow throughput of the siphon system, the siphon system may include a plurality of smaller diameter tubes bundled together, wherein the aggregate flow paths of the bundle of tubes provide at least the desired flow throughput of the siphon system. While the illustrated example depicts a bundle array including nine individual tubes, it will be appreciated that the bundle array may include a greater or fewer number of tubes.

Continuing with the example flow regulator depicted in FIG. 5, when the gate 156 is actuated the gate may expose and/or block a different number of the tubes to achieve the desired flow throughput of water out of the impoundment pool 102 via the siphon system 108. For example, in the illustrated configuration of the flow regulator, there may be six exposed tubes 158 and three blocked tubes 160. It will be appreciated that the number of exposed tubes and blocked tubes will vary depending on the position of the gate 156 (e.g., which may be controlled by the water level of the body of water and the floats 152, 154).

Consistent with the illustrated example embodiment, the flow regulator 150 may include an isolation box 162 (with the front wall being omitted in the depiction of FIG. 5 to allow depiction of the internal features). In general, the isolation box 162 may reduce and/or eliminate wave action and/or currents moving the floats 152, 154. As such, the floats 152, 154, and thereby the gate 156 may achieve an height or position that is based on the average water level (e.g., water level 164) of the body of water 104, and may be less impacted by short term fluctuations in the water level based on wave action or currents. Further, as shown, the isolation box may include side wall water inlets (e.g., side wall water inlets 166). The side wall water inlets may allow water from the body of water 104 to fill the isolation box 162 to a water level 164 of the body of water 104

In some implementations, the impoundment pool 102 may include an overflow spillway (e.g., overflow spillway 128) between the impoundment pool and the body of water to allow discharge of overflow water from the impoundment pool. Consistent with such an implementation, in the event that the impoundment pool was to become filled above a maximum desired water level, water may be able to escape from the impoundment pool back into the body of water. For example, if the siphon system were to become blocked, or otherwise fail to discharge water at a desired rate, the water level in the impoundment pool may rise above a desired maximum level. Similarly, during rough sea conditions, the body of water may experience wave heights that are greater than the height of an impoundment pool wall above the water level of the body of water. As such, waves breaking over the top of the impoundment pool wall may also cause the water level in the impoundment pool to rise above a desired maximum level. The overflow spillway 128 may allow the excess water to escape from the impoundment pool and/or escape at a greater rate than may be achieved via the siphon system alone. As such, the water level in the impoundment pool may be returned to a desired and/or controlled level more quickly than via the siphon system alone.

### General

The terminology used herein is for the purpose of describing particular embodiments only and is not intended to be limiting of the disclosure. As used herein, the singular forms "a", "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. An energy storage system comprising:
an impoundment pool adjacent to a body of water;
an impoundment pool inlet from the body of water into the impoundment pool, the impoundment pool inlet at or below a water level of the body of water; and
a siphon system from the impoundment pool, the siphon having a siphon inlet within the impoundment pool and a siphon discharge outside of the impoundment pool configured to maintain a water level within the impoundment pool lower than a water level of the body of water to produce a continuous inflow of water from the body of water into the impoundment pool.

2. The energy storage system according to claim 1, wherein the siphon discharge is lower than the impoundment pool inlet.

3. The energy storage system according to claim 1 further comprising:
a turbine generator located in an inlet water stream associated with the impoundment pool inlet.

4. The energy storage system according to claim 3, wherein the turbine generator is a bulb turbine generator.

5. The energy storage system according to claim 3, further comprising an intake conduit between the body of water and the impoundment pool inlet, the inlet water stream associated with the impoundment pool inlet flowing through the intake conduit from the body of water to the impoundment pool inlet.

6. The energy storage system according to claim 5, wherein the turbine generator is at least partially disposed within the intake conduit.

7. The energy storage system according to claim 5, wherein the intake conduit includes a venturi system.

8. The energy storage system according to claim 7, wherein the venturi system includes an adjustable venturi gate at an entrance of the intake conduit.

9. The energy storage system according to claim 7, wherein the venturi system includes a venturi profile within the intake conduit, and the turbine generator is disposed adjacent to the venturi.

10. The energy storage system according to claim 3, wherein the turbine generator powers, at least in part, a pump of a pumped storage energy system.

11. The energy storage system according to claim 1, further comprising a flow regulator associated with the siphon system.

12. The energy storage system according to claim 11, wherein the flow regulator includes one or more electromechanical valves.

13. The energy storage system according to claim 11, wherein the flow regulator includes a float valve system.

14. The energy storage system according to claim 13, wherein the float valve system includes a float coupled with a valve to open and close the valve based on a water level of the body of water.

15. The energy storage system according to claim 14, wherein the valve includes a gate movable relative to a siphon flow path to one or more of at least partially expose the siphon flow path and at least partially block the siphon flow path.

16. The energy storage system according to claim 1, wherein the siphon system includes a bundle array of tubes to define a plurality of siphon flow paths between the siphon inlet and the siphon discharge.

17. The energy storage system according to claim 1, wherein the impoundment pool further includes an overflow spillway between the impoundment pool and the body of water to allow discharge of overflow water from the impoundment pool.

18. An energy storage system comprising:
an impoundment pool adjacent to a body of water;
an intake conduit extending between the body of water and an inlet of the impoundment pool, the intake conduit allowing a flow of water from the body of water into the impoundment pool;
a turbine generator at least partially disposed within the intake conduit, wherein the turbine generator is rotated by the flow of water;
a flow concentration system for directing at least a portion of the flow of water one of into the intake conduit and into the turbine generator;
a siphon system configured to maintain a water level within the impoundment pool lower than a water level of the body of water; and
a flow regulator controlling a discharge flow rate from the siphon system.

19. The energy storage system according to claim 18, wherein the flow regulator includes a gate valve controlled, at least in part, by a float assembly, wherein the gate valve controls the discharge flow rate from the siphon system based upon, at least in part, the water level of the body of water.

20. The energy storage system according to claim 19, wherein:
the siphon system includes a bundle array of a plurality of siphon tubes, each of the plurality of siphon tubes defining a respective siphon flow path; and
the gate valve is movably displaceable to expose and block at least a portion of the plurality of siphon tubes to control the discharge flow rate from the siphon system.
